(19) United States
(12) Patent Application Publication
(10) Pub. No.: US 2002/0015179 A1
(43) Pub. Date: Feb. 7, 2002

(54) Network print service system

(75) Inventors: Takashi Igarashi, Tokyo (JP); Hiroyuki Iizuka, Tokyo (JP); Hiroshi Ikeda, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Konica Corporation, Tokyo (JP)

(21) Appl. No.: 09/819,380

(22) Filed: Mar. 28, 2001

(30) Foreign Application Priority Data
Mar. 31, 2000 (JP) 097528/2000

(51) Int. Cl. G06K 1/00

(52) U.S. Cl. 358/1.15; 358/1.13

(57) ABSTRACT

The present invention concerns a network system for providing a print-service, in which a printing process is conducted in response to print-order information transmitted from a customer. The network system includes a first server for conducting the printing process based on the print-order information transmitted from the customer and a second server for providing the print-service to the customer through the network system. When the second server receives the print-order information transmitted from the terminal device located at the site of the customer, the second server stores the print-order information in the information-storing section without transmitting the received information to the first server. When the first server requests the second server to transmit the print-order information, the second server transmits the print-order information, stored in the information-storing section, to the first server, and further, the first server conducts the printing process based on the print-order information received from the second server.

### BACKGROUND OF THE INVENTION

This invention relates to a network print service system for providing a service of image printing to a customer through a network such as Internet.

In a service of printing images and providing them to a customer, in contrast with the service of a conventional type in which a customer brings a silver halide negative film to a laboratory to request printing, it has been proposed a network print service for providing various kinds of services such as ordering additional photographic prints, attaching a photographic image to an electronic mail, and downloading photographic image data, with various kinds of apparatus such as a scanner, a printer, a server computer having a large-capacity disk (hereinafter referred to as an image server) installed in a major laboratory for collecting films and delivering prints, by accumulating photographs taken by customers in the image server, to make it possible for a customer to access the image server through a network.

The advantage of such a network print service as described above is that a customer can make an order of photographic prints as he is at his home or in his office; however actually, because there are some procedures that can not be done through a network such as the receiving of a film and the delivering of prints, it is general to provide services by utilizing photograph shops and mini-laboratories in the local areas as agencies for conveying orders (conveyance agencies).

In this case, the more are the above-mentioned conveyance agencies, the more convenient they are from the standpoint of customers. However, it is the actual situation that the number of collecting-delivering laboratories which receive orders should desirably be one if possible, because of the ease of understanding where to access at the time of ordering or the ease of making the data control. For this reason, in the case where network print service is practiced, it is considered appropriate to concentrate apparatus in a collecting-delivering laboratory, to make it possible to cope with as many conveyance agencies as possible.

However, in the form such that all the apparatus are concentrated in a major collecting-delivering laboratory as described above, it is inevitable that the path of collection and delivery from a conveyance agency to the collecting-delivering laboratory becomes long, and the delivery time of print service is prolonged owing to the waiting time from handing over a film to the conveyance agency to the coming of collecting-delivering opportunity.

In this case, by making the number of collecting-delivering laboratories increase, to shorten the path of collection and delivery and to increase the frequency of collection and delivery, a quick processing can be done; however, there is a problem that the advantage of the ease of understanding where to access and the unitary control of data is lost, and the increase of the frequency of collection and delivery causes to raise the cost of collection and delivery.

For such a problem, in the publication of the unexamined patent application H11-154218, it is disclosed a method in which a central server and laboratory servers are connected by a network, and printing is carried out in a laboratory server in accordance with the print order received by the central server.

However, a problem as described below occurs in this system. In the case where a large number of print orders for New Year's cards, for example, are produced, sometimes a large number of requests for print-processing from the central server are concentrated in each laboratory server at a time. However, a high-performance server is not always provided in a usual laboratory, which is different from the laboratory provided with the central server. For example, it possibly occurs a case where any print order can not be made owing to the network being brought in the busy state. Especially, in the case where image information having comparatively a large data volume is transmitted, the line is easy to be brought in the busy state because it takes a long time. Even it occurs in many laboratory servers, a case where print orders exceed the processing capacity.

### SUMMARY OF THE INVENTION

In view of the above-mentioned problems of the conventional technology, it is an object of this invention to provide a network print service system and a server capable of carrying out a quick order reception by eliminating the ineffective communication at the time of print order, and receiving print orders stably and reliably by managing print orders efficiently.

Accordingly, to overcome the cited shortcomings, the abovementioned object of the present invention can be attained by network systems and servers described as follow.

(1) A network system for providing a print-service, in which a printing process is conducted in response to print-order information transmitted from a customer, comprising: a first server for conducting the printing process based on the print-order information transmitted from the customer, the first server being installed in each of laboratories and having a printer being capable of producing prints; and a second server for providing the print-service to the customer through the network system, the second server receiving at least a part of the print-order information transmitted from a terminal device located at a site of the customer and having an information-storing section to store the print-order information; wherein, when the second server receives the print-order information transmitted from the terminal device located at the site of the customer, the second server stores the print-order information in the information-storing section without transmitting the received information to the first server, and when the first server requests the second server to transmit the print-order information, the second server transmits the print-order information, stored in the information-storing section, to the first server, and further, the first server conducts the printing process based on the print-order information received from the second server.

(2) The network system of item 1, wherein the first server can receive the print-order information transmitted from the terminal device located at the site of the customer and the second server can store image-data in the information-storing section, and, based on the print-order information transmitted from the terminal device located at the site of the customer, the first server requests the second server to transmit the image-data corresponding to the print-order information, and the first server conducts the printing process based on the print-order information and the image-data transmitted from the second server.

(3) The network system of item 1, wherein identification-information of the customer can be registered in either the first server or the second server, and the terminal device located at the site of the customer can be automatically connected to the first server based on the identification-information registered.

(4) The network system of item 1, wherein the first server transmits printing-history data to the second server at a predetermined timing, and the second server stores the printing-history data of the first server as a database.

(5) The network system of item 1, wherein the first server stores first template data.

(6) The network system of item 5, wherein the second server stores second template data, a data amount of which is less than that of the first template data.

(7) A server, installed in each of laboratories, for conducting a printing process in response to print-order information transmitted from a customer, comprising: a connecting section for coupling the server to a printer to transmit image-data to the printer; and a communication section for coupling the server to a network; wherein, through the communication section, the server requests another server, coupled to the network, to transmit the print-order information so as to receive the print-order information from the other server, and, through the connecting section, the server commands the printer to conduct the printing process based on the print-order information received.

(8) The server of item 7, wherein the print-order information, transmitted from a terminal device located at a site of the customer, are received through the communication section, and, in response to the reception of the print-order information, the server requests the other server coupled to the network to transmit image-data corresponding to the print-order information so as to receive the image-data from the other server, and, through the connecting section, the server commands the printer to conduct the printing process based on the print-order information and the image-data received.

(9) The server of item 7, wherein the server transmits printing-history data to the other server at a predetermined timing.

(10) A server for providing a print service in response to print-order information transmitted from a customer, comprising: a communication section for coupling the server to a network; and an information-storing section; wherein, in response to a request transmitted from a terminal device located at a site of the customer, the server receives the print-order information transmitted from the terminal device located at the site of the customer through the communication section and stores the print-order information in the information-storing section, and further, in response to a request transmitted from another server installed in a laboratory, the server transmits the print-order information stored in the information-storing section through the communication section.

(11) The server of item 10, wherein image-data, transmitted from the terminal device located at the site of the customer, are stored in the information-storing section, and further, in response to a request transmitted from another server installed in a laboratory, the server transmits the image-data stored in the information-storing section through the communication section.

(12) The server of item 10, wherein, in response to accessing activities from the terminal device located at the site of the customer, the server transmits service-information for printing to the terminal device located at the site of the customer through the communication section.

(13) The server of item 10, wherein the server receives printing-history data from the other server installed in the laboratory and stores the printing-history data as a database.

Further, to overcome the abovementioned problems, other print service systems and servers, embodied in the present invention, will be described as follow.

In order to accomplish the above-mentioned object, the first print service system of this invention is made to have a structure comprising

at least one first server which is installed in a laboratory provided with a printer capable of outputting an image, and is capable of obtaining print-order information from a customer through a network, and

at least one second server capable of providing the information of a print service to a customer through a network, wherein,

when print-order information which has been prepared on the basis of print service information obtained from said second server is transmitted from a terminal at the customer end to said first server, said first server carries out printing process on the basis of said print-order information transmitted to it.

The second network print service system of this invention is made to have a structure comprising

at least one first server which is installed in a laboratory provided with a printer capable of outputting an image, and is capable of obtaining print-order information from a customer through a network, and

at least one second server capable of providing the information of a print service to a customer through a network, wherein,

when print-order information which has been prepared on the basis of print service information obtained from said second server is transmitted from the aforesaid terminal at the customer end to said first server, said first server transmits an instruction to transfer image information to said second server, and further, carries out printing process on the basis of the image information received from said second server and said print-order information transmitted from said terminal at the customer end.

The third network print service system of this invention is made to have a structure comprising

at least one first server which is installed in a laboratory provided with a printer capable of outputting an image, and is capable of obtaining print-order information from a customer through a network, and

at least one second server capable of providing the information of a print service to a customer through a network, wherein,

when first image information is obtained at said laboratory, said first server stores said first image information, and transmits second image information which has been obtained by converting said first image information to have a less data volume to said second server, to be stored by said second server, and further,

when print-order information which has been prepared on the basis of print service information which is obtained from said second server and includes said second information is transmitted from a terminal at the customer end to said first server, said first server carries out printing process on the basis of said first image information stored in it and said print-order information transmitted from said terminal at the customer end.

The first print service system of this invention is made to have a structure comprising at least one first server which is installed in a laboratory provided with a printer capable of outputting an image and is capable of obtaining print-order information from a customer through a network, and at least one second server capable of providing the information of a print service to a customer through a network, wherein, when print-order information which has been prepared on the basis of print service information obtained from said second server is transmitted from a terminal at the customer end to said first server, said first server carries out printing process on the basis of said print-order information transmitted to it; therefore, even though customers who are willing to make a print order are concentrated in a time period, because said second server provides only print service information, there is a low possibility of the line being brought in the busy state, and on the other hand, because said first server exists in each of the laboratories in which it is installed, the number of the print orders received from terminals of the customer end is distributed, which makes low the possibility of the line being brought in the busy state.

The second network print service system of this invention is made to have a structure comprising at least one first server which is installed in a laboratory provided with a printer capable of outputting an image and is capable of obtaining print-order information from a customer through a network, and at least one second server capable of providing the information of a print service to a customer through a network, wherein, when print-order information which has been prepared on the basis of print service information obtained from said second server is transmitted from the aforesaid terminal at the customer end to said first server, said first server transmits an instruction to transfer image information to said second server, and further, carries out printing process on the basis of the image information received from said second server and said print-order information transmitted from said terminal at the customer end; therefore, with respect to pieces of image information which require a comparatively long transmission time respectively, by transmitting them collectively from said first server to said second server during a time zone when the line is comparatively free, for example, late at night or early in the morning, or when communication cost is comparatively low, the communication time can be made shortened and, at the same time, the line can be prevented from being brought in the busy state.

The third network print service system of this invention is made to have a structure comprising at least one first server which is installed in a laboratory provided with a printer capable of outputting an image and is capable of obtaining print-order information from a customer through a network, and at least one second server capable of providing the information of a print service to a customer through a network, wherein, when first image information is obtained at said laboratory, said first server stores said first image information, and transmits second image information which has been obtained by converting said first image information to have a less data volume to said second server, to be stored by said second server, and further, when print-order information which has been prepared on the basis of print service information which is obtained from said second server and includes said second information is transmitted from a terminal at the customer end to said first server, said first server carries out printing process on the basis of said first image information stored in it and said print-order information transmitted from said terminal at the customer end; therefore, because a customer can request a desired process such as image composition to said first server through looking at the second image information included in the print service information provided from said second server, an operation with a heavy load such as image transmission can be omitted, which is convenient. In such a case, because the second image information provided from said second server has a smaller data volume than the first image information, it needs only a short transmission time, which makes low the possibility of the line being brought in the busy state.

Further, if the aforesaid first server or second server is capable of registering the identification information of customers, and the aforesaid terminal at the customer end is capable of being automatically connected to the aforesaid at least one first server, the connected customer can be identified on the basis of said identification information; therefore, for example, automatic billing becomes possible, which is convenient.

Further, if the aforesaid first server is specified in such a manner as to transmit information concerning the history of printing to the aforesaid second server at a predetermined timing, and said second server collects the pieces of information concerning the history of printing of said first server through a network or the like, makes it a database, and stores it, it becomes possible, for example, a summation such as in which time of the year and in which laboratory the number of print orders becomes larger, which is convenient.

Further, if the aforesaid first server stores template information, image composition can be simply done on the basis of such template information, which is convenient.

Further, if the aforesaid second server compresses the aforesaid template information which the aforesaid first server stores, and stores the template information having a small data volume, it becomes possible to confirm a template or an image produced by image composition through downloading it within a comparatively short access time, which is convenient.

In the above description, “the first server” may be a server computer which is installed in an individual laboratory such as a shop-front mini-laboratory for example, and “the second server” may be a server computer which is installed in a service center which makes a centralized control of image data; anyway, it is desirable that both are equipped with a data memorizing device such as a hard disk having a sufficient capacity for storing necessary image data. The first server fulfils the duty as what is called a printer server, and it is desirable that the first server is connected to a photographic printer (connected in a way capable of switching if there are plural photographic printers).

Further, “print-order information is transmitted” means that the content of an order is transmitted as order information of a specified data form. To state it concretely, it can be considered, for example, that the format of order information is publicly disclosed on the home page memorized in a second server through Internet, and a customer is requested to transmit the order information which is prepared in accordance with the format by electronic mail to a first server. Further, it is also appropriate to make the procedure such one that, when a customer inputs the content of an order on a predetermined screen, the content is automatically converted into the format of order information, and is transmitted to a first server.

Further, “image information obtained at a laboratory” means image information obtained by scanning a film, which has been brought to a laboratory by a customer of the laboratory for requesting simultaneous printing (printing accompanying the development of the film), by a scanner to make image data, but it is not limited to this. For example, it includes image information obtained by one of various kinds of data reading-transmitting means such as a card reader from a memory of a digital camera which has been brought by a customer. After that, these kinds of image information are to be handled as digital image data.

If this reading process is carried out in each laboratory, collection-and-delivery time and waiting time for collection-and-delivery can be eliminated, which makes it possible to shorten delivery time.

Moreover, in this specification, “a network” means any one of various kinds of networks having enough communication speed for transmitting order information and image data such as a dedicated line, a CATV network, a dial-up connected line, and a LAN, which are available for Internet.

Further, in this invention, because the first server stores original image information, and the second server stores image data having a small data volume such as thumbnail image data, in the case where a customer requests additional prints of a photographic image, it is frequently done to select the photograph to be printed additionally by visually checking all the photographs taken against the requested one; in this case, the comparison with the eye can be efficiently made by receiving image information having a small data volume from a second server at a terminal at the customer end.

Further, “eprinting process” means all kinds of processes required for providing prints to a customer. For example, it includes not only a process required for the printing of a real image, but also a process required for composition of an image with a template image or composition of a panoramic image. That is, “printing process” means not only mere outputting of prints by a printer, but also a series of processes including the above-mentioned data processing.

Moreover, “print-order information” means, to state it concretely, the process number denoting the content of service (such as additional printing and making post cards), the image number denoting an image memorized in the first server installed in a laboratory, the print size, the number of prints, etc.

Further, it is desirable that each of the first servers store images taken by customers of the laboratory, in which the first server is installed, as high-resolution image data. Owing to this, at the time of additional printing ordered by a customer or some other processing, it becomes unnecessary to obtain digital image data from another laboratory.

Further, in the case where each of first servers stores digital image data of the customers, it is possible to let digital image data, which are stored in second servers and capable of being accessed, be low-resolution image data having a smaller data volume than the high-resolution image data stored in said first server. That is, it is possible to use the digital image data in the first server for outputting prints, and the digital image data in the second servers for perusal through a network separately.

Further, in the case where print-order information is transmitted to the first server in a laboratory other than the laboratory storing the digital image data from a terminal at the customer end, transmission of image data is necessary between these first servers; therefore, the cost of the print service is raised by the communication expense necessary for the data transmission. Further, in the case where such data transmission is made, not only the laboratory which outputs the prints but also the laboratory which stores the digital image data contributes to the providing of the printing service; therefore, the charge obtained from the customer should be distributed to the two laboratories. Then, it is appropriate that the second server grasps the situation of operation of all the first servers and controls the trades produced between one and another laboratory and those produced between each laboratory and customers, to utilize it, for example, in the control of charge imposed on customers and electronic settlement of accounts.

Now, “print service” in this specification includes not only the service of making the above-mentioned additional prints and postcards with a photograph attached, but also all the incidental services which are carried out before delivering photographic prints to a customer's hand. To state it concretely, for example, a service to mail or deliver home finished prints without letting them be ones to be received at a shop front, a service to notify a customer that prints have been finished by electronic mail, a service to notify a customer by electronic mail that the storing period of the digital image data in the first server is terminating, a service to extend the storing period in response to an electronic mail from a customer, a service to make it possible for a customer to designate a laboratory to receive prints, a service to return ordered prints put in an album, a service to return prints pasted on a mount with a picture pattern in the case of a memorial photograph, etc. can be thought of.

Accordingly, it is assumed that “print-order information” includes also all kinds of information required for incidental services such as the way of receiving prints, the address of the receiving person, and the electronic mail address, and as a matter of course, such information is not merely referred to, but is capable of being utilized in various processes. That is, for example, it can be thought of to carry out a process such that, in the case where mailing of prints is specified in the “print-order information”, with a printer for printing mailing labels connected to a laboratory server, the mailing label is automatically printed out by referring to the address and name of the receiving person included in the specifying information. In addition, this print of the mailing label may be outputted by a printer which practices printing operation, and by making it come to the uppermost position of the print arrangement, the ease of recognition becomes good.

Moreover, in a service to make a processed print such as a composite image, a method of utilizing a template is known; it is also appropriate to make the system such one that, in the case where such kind of service is provided, the template information having a small data volume (for example, template ID) is stored in the aforesaid first server, and by making the template information capable of being accessed on a network, a customer can order a processed print utilizing the template.

Now, “information concerning a template” may be a template itself, or may be information indicating the identification of a template or the storing position of it.

Besides, in this specification, it is assumed that a template includes not only data but also a procedure of a process such as a macro. To state it concretely, for example, it is possible to let it be a template, a background image provided with a blank area for placing an image, or it is also possible to let it be a template, a set composed of such a background image and the procedure such that “Insert the designated image in the blank area of the background image”. Further, there is also a case where only a procedure such as “Rotate the designated image by 90 degrees”, or “Lower the chroma of the designated image” is regarded as a template, to make an image be rotated by 90 degrees when this template is applied to the image.

### BRIEF DESCRIPTION OF THE DRAWINGS

Other objects and advantages of the present invention will become apparent upon reading the following detailed description and upon reference to the drawings in which:

FIG. 1 is a schematic drawing showing a network print service system of this embodiment;

FIG. 2 is a drawing showing an example of order information;

FIG. 3 is a drawing showing another example of order information; and

FIG. 4 is a flowchart of ordering and delivering processes performed between a center server and laboratory servers.

### DETAILED DESCRIPTION OF THE PREFERRED EMBODIMENT

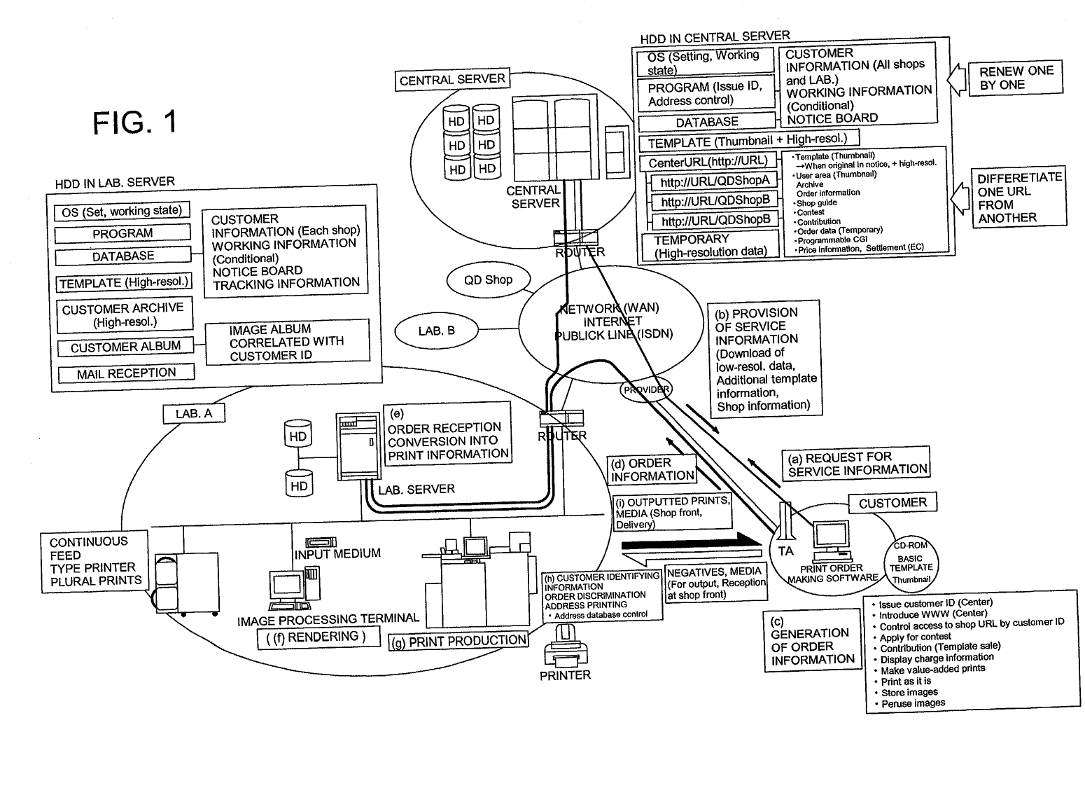

In the following, this invention will be explained by referring to the embodiment of the invention. FIG. 1 is a schematic drawing showing a network print service system of this embodiment. The terminal at the customer end 1, the laboratory server 2 as a first server provided with the hard disk 2a, and the central server 3 as a second server provided with the hard disk 3a are connected to the network WAN such as Internet. In a laboratory, the laboratory server 2 is connected to the image processing terminal 3 and the printer 4 through a LAN. In addition, although not shown in the drawing, the laboratory server 2 is installed in each of the plural laboratories, and also for the central server 3, a plurality of them are provided.

Next, the modes of carrying out print service using this system will be explained.

(1) Direct Print Service

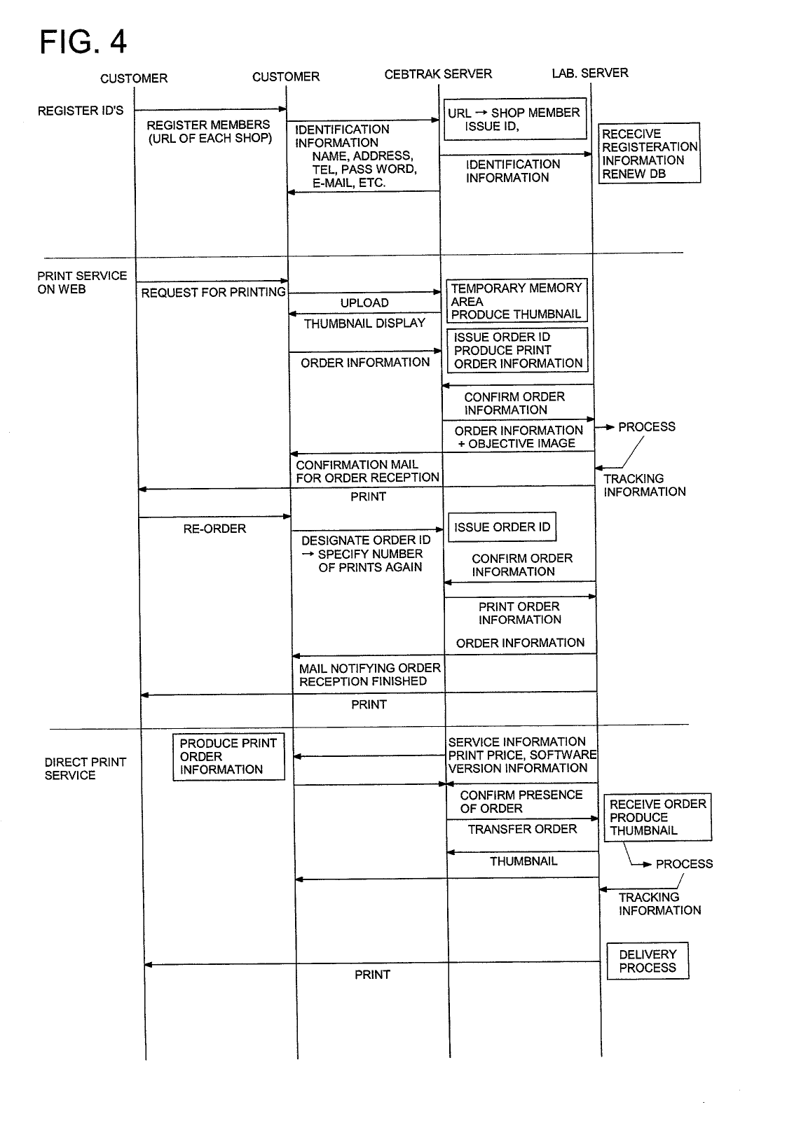

Referring to FIG. 1 and FIG. 4, a process of ordering and delivering will be detailed in the following.

A customer can obtain service information by actuating a software (installed beforehand) for issuing a print order at the terminal at the customer end 1 and accessing the central server 3 designated by the URL (FIG. 1(a), FIG. 1(b) and numeral 11 of FIG. 4). Service information referred to here means the information showing the content of service such as the preparation of post cards, preparation of calling cards, and “print as it is”, and the information concerning the price, the delivery time, etc.

A customer can make the print-order information by selecting the desired items from a menu of these, and inputting suitable necessary articles (FIG. 1(c)) by using the terminal at the customer end 1. To explain it more concretely, for example, in the case where the customer desires the preparation of post cards using an image owned by himself, he can select “Preparation of post cards” from the menu. In such a case, first, the customer makes selection of a template for the image composition. Usually, because a basic template exists in a CD-ROM in which a software for preparing a print order is memorized, it is appropriate to use this, but in the case where there is no desirable one, it can be done by referring to the predetermined URL, to download its low-resolution image as one of bits of service information.

Next, the customer can read out the image information which has been made a digital image data beforehand from a medium such as a digital camera, and insert it into the specified position of the template.

After that, the customer inputs the individual information consisting of the address, name, telephone number, etc., to make up the information for preparing post cards. In this case, if the designation of the template etc. is done not by image information but by a sign (including a number) capable of being recognized commonly with the laboratory side, the data volume becomes small; that is desirable. The information of the inserted image, the information of the characters, together with the print size and the number of the prints are described in the form of a text, and finally, an order identification is attached to the form; these pieces of information are called collectively print-order information (numeral 12 in FIG. 4).

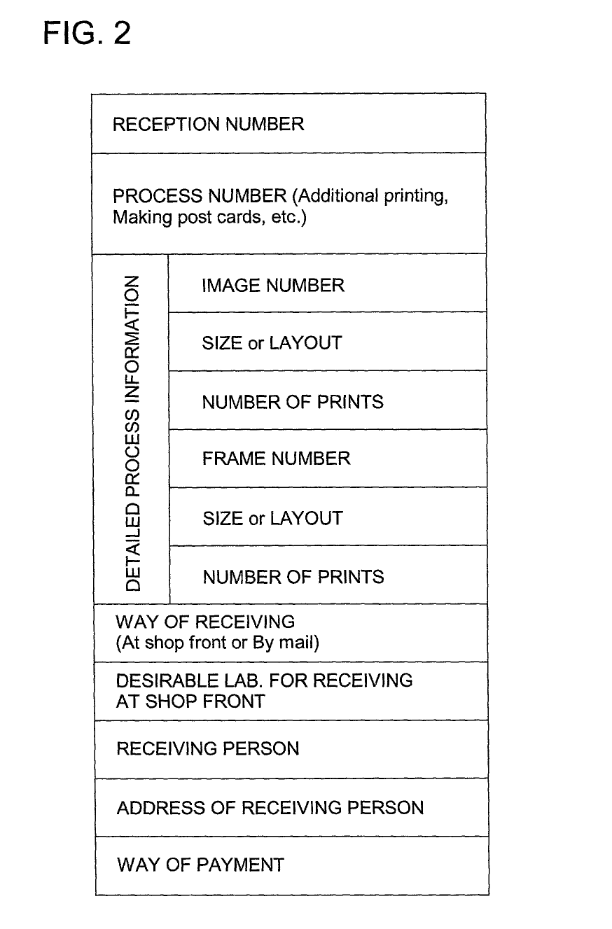

Now, the print-order information, which the customer is supposed to make, is such one as shown in FIG. 2, for example, and together with the information necessary for the additional prints such as the frame number, size, and number of prints, the way of receiving the finished prints etc. are included in it. Further, in an order for a processed print, also the number of the template is included in this print-order information. Besides, the content of services capable of being provided through a network includes not only a service accompanied by print output but also every thing concerning print service. For example, in the case where the storing period of the digital data in the laboratory server 2 will terminate in a few days, but the photograph of which the customer wishes to make additional prints is not yet determined, a service for the request to extend the storing period can be considered.

Here, the order information is appropriate so long as it represents the print-order information uniquely, and for example, it may be such one as to have a form of an ID for specifying a customer (to be described later) with date, hour, minute, and second attached.

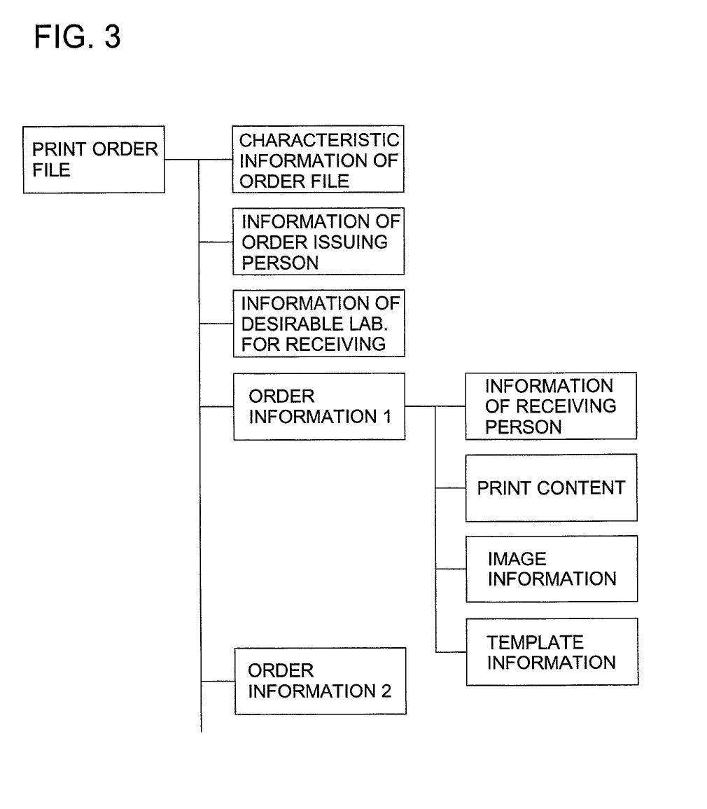

Further, various kinds of the data structures of the order information can be considered. For example, Microsoft Corp. has proposed the “Structured Storage” technology in which several kinds of data having different natures respectively are memorized in a file with a hierarchical structure, and it is possible to prepare order information as the order file shown in FIG. 3 by utilizing this technology.

In another case, a customer carries out transmission of print-order information to the central server (13 in FIG. 4), and the print-order information belonging to each laboratory is stored in each area of the central server corresponding to each laboratory; the laboratory server end makes confirmation at an arbitrary timing if print-order information is present at the central server end (14 in FIG. 4), and if it is present, the central server transfers the information to the laboratory server end (15 in FIG. 4).

After an order is received, thumbnails in the received order are produced in the laboratory (16 in FIG. 4), and in order that the customer may confirm the state of the order, they are sent back to the central server together with the order information (17 in FIG. 4). A mail of confirmation for the order reception is sent back to the customer concurrently with it.

The merit of making the above-mentioned confirmation for the print-order information by the laboratory server end at an arbitrary timing is that an order can be practiced when the load to the printer and its peripheral apparatus is small depending on the situation of operation in the laboratory, which improves the efficiency, that an access from the outside can be prevented because the connection with Internet is not ordinarily made, and that also a dialup connection etc. except Internet from the outside can be rejected, which improves security.

Further, the customer transmits the prepared print order together with a file attached at need (such as the image information of a digital camera) to the laboratory server 2 of the laboratory he designates by e-mail or the like (FIG. 1(d)), and the laboratory server 2, having received this, carries out composition processing (rendering) etc. at need by the image processing terminal 3 (FIG. 1(f)), and then practices printing by the printer 4 (FIG. 1(g)). In this case, it is possible to lower the accessing frequency to the center server considerably. In addition, in the case where the name, address, etc. of the customer are included in the print-order information, in order to protect the privacy of an individual, it is desirable to carry out coding with respect to text data particularly, by using PGP (Pretty Good Privacy) or the like.

For the outputted prints, it is necessary to discriminate them for each order (FIG. 1(h), and it is desirable that address writing is done on the basis of the print-order information if mailing is specified. Further, also in the case of receiving the prints at the shop front, if the print-order information comes to the uppermost position of the image prints, confirmation of it becomes easy and also the operation can be done easily. After that, the printed images are to be provided to the customer by way of receiving at the shop front, mailing, or the other in accordance with the order of the customer (FIG. 1(i) and 19 of FIG. 4).

(2) Print Service on the Web

A customer can make an order for a print service using a browsing software such as Internet Explorer (made by Microsoft Corp.). In this case, the customer accesses the central server 3 from the terminal at the customer end 1, and copying is carried out by uploading the order information including the image information owned by him in his personal computer (21 in FIG. 4). This order information is memorized in the hard disk 3a (22 in FIG. 4). For the memorized images, thumbnails are produced (22 in FIG. 4), and it is possible for the customer to input order information such as the number of prints and the size (24 in FIG. 4), as he confirms the thumbnail images from on the browser (23 in FIG. 4). In the central server, an order ID is issued when the order is settled.

In this case too, the print-order information prepared at the customer side is stored in the central server as data for the laboratory server 2 designated. In the laboratory server 2, it is carried out the confirmation to the central server at an arbitrary timing if the print-order information is present (26 in FIG. 4), and if it is present, the print-order information is distributed from the central server 3 to the laboratory server 2 by using a protocol such as FTP (27 in FIG. 4). A mail of confirmation for the order reception is sent to the customer (28 in FIG. 4), and the printer 4 forms prints, to make it possible to deliver them to the customer (29 in FIG. 4).

Further, the whole of the print-order information is not stored in the central server, but it is possible to deal with it in the following way. In this case, by accessing from the terminal at the customer end 1 to the central server 3, the customer carries out copying through uploading the image information owned by him in his personal computer. This image information is memorized in the hard disk 3a.

In this case too, the print-order information produced at the customer end is transmitted to the laboratory server 2 designated, and the laboratory server 2 gives the instruction to the central server 3 for transmitting the image information which has been copied, on the basis of the information specified by the print-order information received. This image information is distributed from the central server 3 to the laboratory server 2 by using a protocol such as FTP. On the basis of the print-order information received through the laboratory server 2 and the transferred image information, the printer 4 can form the prints.

Further, the above-mentioned image information memorized in the hard disk 3a is now deleted after it is confirmed that data copy has been made in the laboratory server, or that printing process has been done, or it is judged that no re-order to be described later (a second order) will be made (it will not be utilized for a certain period).

A re-order is a function to make it possible that, on the basis of the memorized print-order information indicated by an order ID which has been issued by a customer within a certain period past, the customer designates the order ID of his object from a browser (31 in FIG. 4), to call out the print-order information, carries out only specifying the number of prints and the size without carrying out again the upload of image data to make a heavy load, and produces the print-order information in a simple way. In this case, when the designation is finished, an order ID is issued again, and because the image information has already been transmitted to the laboratory server, only the print-order information with the image information deleted is produced for the same laboratory server as the previous one (32 in FIG. 4). In the laboratory server, the confirmation of the order information is carried out (33 in FIG. 4), and when it obtains the print-order information (34 in FIG. 4), it transmits a mail notifying the completion of order reception to the customer (35 in FIG. 4), and delivers the prints to the customer (36 in FIG. 4).

By doing in this way, it becomes possible to issue an order without sending and receiving image information making a heavy load between a customer and the central server, and between the central server and a laboratory server.

(3) Print Service Utilizing Archive

In the case where printing of a silver halide negative film or reversal film is done in a laboratory by a customer's order, it is possible that, in response to the customer's request, such images are scanned to make high-resolution image data, which are stored in the hard disk 2a of the laboratory server 2. In the case where the customer orders re-printing on the basis of the high-resolution data, as confirming the images through Internet, it is also possible for the customer to confirm such high-resolution data by accessing the laboratory server 2 from the terminal at the customer end 1. However, it takes time to download all the plurality of high-resolution data to confirm them.

Therefore, in this embodiment, after the compression of image information has been done in the laboratory server 2, the image data having a small data volume such as image data of a thumbnail image are transmitted to the central server 3, and stored in the hard disk 3a . The central server 3 can disclose the information on the Web on condition that access is limited to the customer only.

To state it more concretely, the central server 3 stores the thumbnail image data transmitted from each of the laboratories as described in the above in correspondence with the laboratory which has transmitted the thumbnail image data, while it makes the thumbnail image data capable of being accessed on the network. In this case, because it is necessary for the customer only to be able to confirm the photograph by the thumbnail image, a high image quality is not necessary particularly. Further, it is desirable to make the data volume of the thumbnail image as small as possible for the purpose of saving the disk space too. In this embodiment, the digital image data, which the laboratory server 2 stores, have 4 bases (the number of pixels: about 1536×1024) which are necessary for outputting an L-size print at 300 dpi, while the digital image data, which the central server 3 stores for the access through the network, have 1/4 base (the number of pixels: about 384×256). Further, the central server 3 stores also the thumbnail image data of the templates which the above-mentioned laboratory server 2 stores, in order that any customer may access them through the network.

By referring to this image information publicly disclosed on the Web, the customer carries out the preparation of the print-order information on the basis of the image number, which makes it possible to produce additional prints by transmitting the print-order information in the form including image information to the laboratory server 2.

Further, the laboratory server 2 can store high-resolution templates in addition to the high-resolution image data of customers. Moreover, the central server 3 can store low-resolution templates corresponding to such high-resolution templates, and it is appropriate that new one is registered in the central server 3, whenever a new template is produced in the laboratory. On the other hand, also the low-resolution image data corresponding to high-resolution image data can be registered in the central server in response to the request of customers.

By referring to low-resolution image data (thumbnail image data) which are disclosed publicly on the central server 3 and a low-resolution template (and downloading at need), the customer can combine them on the terminal at the customer end 1 (on the personal computer, for example). However, the processing such as composition carried out here is one that is done for the purpose of preparing the order information, and the processed image obtained by the processing is used only for confirmation. The procedure of the processing that the customer carried out is recorded by the function of a dedicated software built in the terminal at the customer end 1, and is included in the print-order information as a part of it when it is produced. Further, in this print-order information, information indicating an image designated by the customer, and information indicating a template used by the customer in processing.

The print-order information including the thumbnail image data and the low-resolution template data is transmitted from the terminal at the customer end 1 to the laboratory server 2, and on the basis of the print-order information, the laboratory server 2 can retrieve the high-resolution template corresponding to the low-resolution template and the high-resolution image data corresponding to the thumbnail image from in the hard disk 2a, carry out processing in accordance with the processing procedure included in the print-order information in the image processing terminal 4, and output the prints from the printer 5.

As explained in the above, by storing high-resolution data of templates in each of the laboratories in the same manner as image data of customers, in the case where making a service for a processed print is instructed from the central server 3 to the laboratory server 2, it is not necessary to transfer high-resolution template data, which makes it possible to decrease the load of the network or the cost of communication.

Further, if it is done to convert template images, which are stored in the hard disk 3a of the central server 3, into low-resolution data for monitor display to be stored in it, the disk space of the central server 3 can be saved.

Besides, the customer may give permission for printing by referring to the aforesaid Web page to a person whom he has given a specified ID such as a friend of his. In this case, in the case where the friend designates the laboratory server 2 which is installed in another laboratory, by requesting the transmission of data from the laboratory server 2 designated by the friend to the laboratory server 2 having the high-resolution data, the transfer of image information is carried out between the two laboratory servers 2; therefore, printing becomes possible in the other laboratory.

Further, it is desirable that a customer has a unique ID as identifying information of himself, (including name, address telephone number, password, e-mail address, etc.). Such an ID is issued by any one of the laboratories, and collected in the network-joined union. Further, a customer carries out inputting the identification information on the central server (41 in FIG. 4); thus, the central server carries out issuing an ID (42 in FIG. 4), transmits data to the shop belonging to it on the basis of the identification information (43 in FIG. 4), and renews the database (DB) (44 in FIG. 4). By sending a notification of completion of registration to the customer concurrently with the operation, the same result can be obtained. If such an ID is registered in the laboratory server 2 or in the central server 3, it becomes possible for example, automatic billing in accordance with the print order of a customer.

It is appropriate to designate the URL, to which access is to be usually made from the terminal of the customer end 1, at the time of issuing an ID. For example, in the case where a dedicated software for issuing a print order is used, it is convenient if the URL to be automatically accessed by the ID number information is defined, and the service information is obtained from the URL. Further, not a dedicated software but a web browser such as Internet Explorer or Netscape Navigator can be used. In this case also, at the timing when a customer has accessed the URL of the central server 3 and inputted the ID number, it becomes possible to access the URL of the designated laboratory, and a dedicated service can be done.

Further, if the system is made such one that each of the laboratory servers 2 transmits the information concerning the history of printing at a predetermined timing (every other week, for example), and the central server 3 makes a database of the received information concerning the history of printing of the laboratory server 2, and store it, it becomes possible, for example, a summation such as in which time of the year and in which laboratory the number of print orders becomes larger, which is convenient.

Further, if the system is made such one that, in the case where a service of a processed print utilizing a template is provided as the above-mentioned print service, an order is received by disclosing publicly templates together with the customer's image information on the central server 3, and the information designating the template to be used in processing is transmitted to the laboratory server 2, it becomes possible to prepare a simple composite photograph in a laboratory, and a quick service for a processed print can be provided.

Up to now, this invention has been explained by referring to the embodiment, but this invention should not be construed as limited to the above-mentioned embodiment, and it is a matter of course that the invention can be suitably altered and improved.

The first print service system of this invention is made to have a structure comprising at least one first server which is installed in a laboratory provided with a printer capable of outputting an image, and is capable of obtaining print-order information from a customer through a network, and at least one second server capable of providing the information of a print service to a customer through a network, wherein, when print-order information which has been prepared on the basis of print service information obtained from said second server is transmitted from a terminal at the customer end to said first server, said first server carries out printing process on the basis of said print-order information transmitted to it; therefore, even though customers who are willing to make a print order are concentrated in a time period, because said second server provides only print service information, there is a low possibility of the line being brought in the busy state, and on the other hand, because said first server exists in each of the laboratories in which it is installed, the number of the print orders received from terminals of the customer end is distributed, which makes low the possibility of the line being brought in the busy state.

The second network print service system of this invention is made to have a structure comprising at least one first server which is installed in a laboratory provided with a printer capable of outputting an image, and is capable of obtaining print-order information from a customer through a network, and at least one second server capable of providing the information of a print service to a customer through a network, wherein, when print-order information which has been prepared on the basis of print service information obtained from said second server is transmitted from the aforesaid terminal at the customer end to said first server, said first server transmits an instruction to transfer image information to said second server, and further, carries out printing process on the basis of the image information received from said second server and said print-order information transmitted from said terminal at the customer end; therefore, with respect to those pieces of image information which require a comparatively long transmission time, by transmitting them collectively from said first server to said second server during a time zone when the line is comparatively free, for example, late at night or early in the morning, or when communication cost is comparatively low, the communication time can be made shortened and, at the same time, the line can be prevented from being brought in the busy state.

The third network print service system of this invention is made to have a structure comprising at least one first server which is installed in a laboratory provided with a printer capable of outputting an image, and is capable of obtaining print-order information from a customer through a network, and at least one second server capable of providing the information of a print service to a customer through a network, wherein, when first image information is obtained at said laboratory, said first server stores said first image information, and transmits second image information which has been obtained by converting said first image information to have a smaller data volume to said second server, to be stored by said second server, and further, when print-order information which has been prepared on the basis of print service information which is obtained from said second server and includes said second information is transmitted from a terminal at the customer end to said first server, said first server carries out printing process on the basis of said first image information stored in it and said print-order information transmitted from said terminal at the customer end; therefore, because a customer can request a desired process such as image composition to said first server through looking at the second image information included in the print service information provided from said second server, an operation with a heavy load such as image transmission can be omitted, which is convenient. In such a case, because the second image information provided from said second server has a smaller data volume than the first image information, it needs only a short transmission time, which makes low the possibility of the line being brought in the busy state.

Further, if the aforesaid first server or second server is capable of registering the identification information of customers, and the aforesaid terminal at the customer end is capable of being automatically connected to the aforesaid at least one first server, the customer connected can be identified on the basis of said identification information; therefore, for example, automatic billing becomes possible, which is convenient.

Further, if the aforesaid first server is specified in such a manner as to transmit information concerning the history of printing to the aforesaid second server at a predetermined timing, and said second server collects the information concerning the history of printing of said first server through a network or the like, makes it a database, and stores it, it becomes possible, for example, a summation such as in which time of the year and in which laboratory the number of print orders becomes larger; that is convenient.

Further, if the aforesaid first server stores template information, image composition can be simply done on the basis of such template information, which is convenient.

Further, if the aforesaid second server compresses the aforesaid template information which the aforesaid first server stores, and stores the template information having a small data volume, it becomes possible to confirm a template or an image produced by image composition through downloading it within a comparatively short access time, which is convenient.

According to this invention, it is possible to provide a network print service system capable of carrying out a quick order reception through eliminating the ineffective communication at the time of print order, and receiving print orders stably and reliably by preventing the concentration of accesses to the central server.

Disclosed embodiment can be varied by a skilled person without departing from the spirit and scope of the invention.

What is claimed is:

1. A network system for providing a print-service, in which a printing process is conducted in response to print-order information transmitted from a customer, comprising:
a first server for conducting said printing process based on said print-order information transmitted from said customer, said first server being installed in each of laboratories and having a printer being capable of producing prints; and
a second server for providing said print-service to said customer through said network system, said second server receiving at least a part of said print-order information transmitted from a terminal device located at a site of said customer and having an information-storing section to store said print-order information;
wherein, when said second server receives said print-order information transmitted from said terminal device located at said site of said customer, said second server stores said print-order information in said information-storing section without transmitting the received information to said first server, and when said first server requests said second server to transmit said print-order information, said second server transmits said print-order information, stored in said information-storing section, to said first server, and further, said first server conducts said printing process based on said print-order information received from said second server.

2. The network system of claim 1,
wherein said first server can receive said print-order information transmitted from said terminal device located at said site of said customer and said second server can store image-data in said information-storing section, and, based on said print-order information transmitted from said terminal device located at said site of said customer, said first server requests said second server to transmit said image-data corresponding to said print-order information, and said first server conducts said printing process based on said print-order information and said image-data transmitted from said second server.

3. The network system of claim 1,
wherein identification-information of said customer can be registered in either said first server or said second server, and said terminal device located at said site of said customer can be automatically connected to said first server based on said identification-information registered.

4. The network system of claim 1,
wherein said first server transmits printing-history data to said second server at a predetermined timing, and said second server stores said printing-history data of said first server as a database.

5. The network system of claim 1,
wherein said first server stores first template data.

6. The network system of claim 5,
wherein said second server stores second template data, a data amount of which is less than that of said first template data.

7. A server, installed in each of laboratories, for conducting a printing process in response to print-order information transmitted from a customer, comprising:
a connecting section for coupling said server to a printer to transmit image-data to said printer; and
a communication section for coupling said server to a network;
wherein, through said communication section, said server requests another server, coupled to said network, to transmit said print-order information so as to receive said print-order information from the other server, and, through said connecting section, said server commands said printer to conduct said printing process based on said print-order information received.

8. The server of claim 7,
wherein said print-order information, transmitted from a terminal device located at a site of said customer, are received through said communication section, and, in response to the reception of said print-order information, said server requests the other server coupled to said network to transmit image-data corresponding to said print-order information so as to receive said image-data from the other server, and, through said connecting section, said server commands said printer to conduct said printing process based on said print-order information and said image-data received.

9. The server of claim 7,
wherein said server transmits printing-history data to the other server at a predetermined timing.

10. A server for providing a print service in response to print-order information transmitted from a customer, comprising:
a communication section for coupling said server to a network; and
an information-storing section;
wherein, in response to a request transmitted from a terminal device located at a site of said customer, said server receives said print-order information transmitted from said terminal device located at said site of said customer through said communication section and stores said print-order information in said information-storing section, and further, in response to a request transmitted from another server installed in a laboratory, said server transmits said print-order information stored in said information-storing section through said communication section.

11. The server of claim 10,
wherein image-data, transmitted from said terminal device located at said site of said customer, are stored in said information-storing section, and further, in response to a request transmitted from another server installed in a laboratory, said server transmits said image-data stored in said information-storing section through said communication section.

12. The server of claim 10,
where, in response to accessing activities from said terminal device located at said site of said customer, said server transmits service-information for printing to said terminal device located at said site of said customer through said communication section.

13. The server of claim 10,
where in said server receives printing-history data from the other server installed in said laboratory and stores said printing-history data as a database.
